(19) United States
(12) Patent Application Publication
(10) Pub. No.: US 2010/0003135 A1
(43) Pub. Date: Jan. 7, 2010

(54) BLANK CONFIGURABLE AS A MANUALLY OPERABLE FAN OR DISPLAY

(75) Inventor: Peter William Henry Meyerratken, New South Wales (AU)

Correspondence Address: WOOD, HERRON & EVANS, LLP, 2700 CAREW TOWER, 441 VINE STREET, CINCINNATI, OH, 45202, US

(73) Assignee: JUST CHILL PTY. LTD., New South Wales (AU)

(21) Appl. No.: 12/373,005

(22) PCT Filed: Jul. 12, 2007
(86) PCT No.: PCT/AU07/00968

§ 371 Date: Jan. 8, 2009

(30) Foreign Application Priority Data
Jul. 12, 2006 (AU) 2006903762
Dec. 22, 2006 (AU) 2006907155

(51) Int. Cl. A45B 27/00; B23P 17/00; B32B 3/00; G09F 19/00

(52) U.S. Cl. 416/71; 29/592; 417/436; 428/12; 40/1

(57) ABSTRACT

Disclosed is a blank (200) formed of resiliently flexible sheet material. The blank comprises a first portion (208) operative in a planar configuration and a second portion (204) having means (210, 218) for joining thereof upon configuring of the second portion to form a tubular structure (240). Also disclosed are a manually operable fan configurable from the blank, and a display article configurable form the blank.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### TECHNICAL FIELD

The present invention relates to a unitary blank, one or more articles configurable from the blank, and a method for configuring a fan or a display from the blank.

### BACKGROUND

Hand or manually operable fans are well known in the art. These typically include so-called paddle fans where a somewhat circular, heart or cloven shaped blade is mounted upon the end of a stick. The stick is able to be held by a user to create a fanning motion. Other manually operable fans include concertina-type fans, popular throughout Asia and in Spanish culture. The concertina-type fan has the advantage that it is able to be folded when not in use and thus can be easily stowed. Such fans however are relatively delicate and must be handled carefully to ensure the folding fan blade, which is typically formed of paper or fabric, does not break. Paddle type fans are much simpler in construction yet are difficult to stow. The multi-part construction of each of the paddle and concertina fans increase their cost of manufacture.

### SUMMARY

According to the present disclosure, a blank formed of a single sheet of material. The blank is configurable to form one or both of a display or a manually operable fan. The blank has a first portion operative in a planar configuration and a second portion having means for joining onto itself upon configuring of the second portion to form a tubular structure. Desirably, the means for joining comprises structures permitting operative interengagement of parts of the second portion. Where the material has substantial resilient flexibility, such as a plastics material, the configuring can comprise rolling, and the tubular structure comprises a substantially cylindrical tube. Where the material is less flexible, such as paper board or card board, the configuring can comprise folding and the tubular structure may be polygonal in section, such triangular or of similar shape.

The present disclosure presents wide variety of alternate implementations including a range of blank shapes and different approaches to the configuring to achieve alternate display or fan performance.

### BRIEF DESCRIPTION OF THE DRAWINGS

A number of preferred embodiments of the present invention will now be described with reference to the drawings in which:

FIGS. 1A to 1J illustrate a blank and the formation of a fan from the blank according to one implementation;

FIG. 2 is a plan view of a blank which may be configured for use as an article, such as a fan or a display;

FIG. 3 is a side perspective view of an article formed using the blank of FIG. 2;

FIG. 4A is an underside perspective view of the article of FIG. 3;

FIG. 4B is an underside plan view of the fan of FIG. 3;

FIG. 5 is a rear elevation view of the article of FIG. 3;

FIG. 6 is an enlarged perspective view of the interconnection of the blank to form a tube of the article of FIG. 3;

FIG. 7 is a plan view of a further blank;

FIG. 8 is a representation of assembly instructions that may be printed on the blank of FIG. 2, for example;

FIG. 9 is a plan view of an alternate blank;

FIG. 10 is a plan view of a further blank;

FIGS. 11, 12 and 13 are further views of the blank of FIG. 10 when formed;

FIG. 14 is a plan view of a further blank;

FIG. 15 is a perspective view the blank of FIG. 1421 when formed;

FIG. 16 is a plan view of a further blank;

FIGS. 17, 18 and 19 are further views of the blank of FIG. 17 when formed;

FIG. 20 is a plan view of a further blank; and

FIG. 21 shows a further blank.

### DETAILED DESCRIPTION INCLUDING BEST MODE

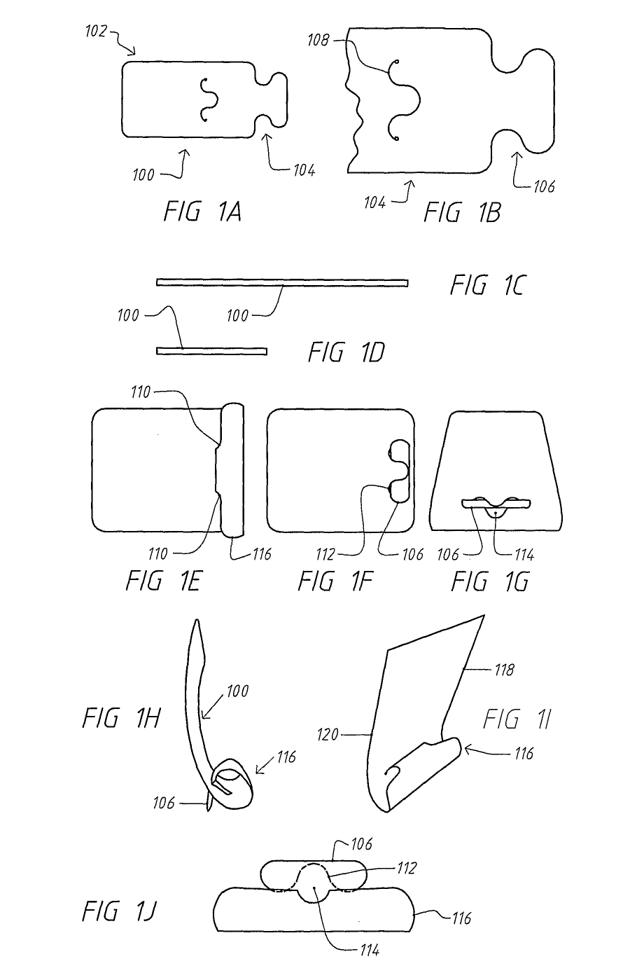

FIG. 1A shows a blank 100, which is formed of a resiliently flexible sheet material. The blank 100 as illustrated is generally rectangular and has a first portion 102 and a second portion 104. Other shapes, as discussed later, may be used. The second portion 104 is configured with a means for joining to permit self-coupling through manual manipulation.

In one implementation, the means for joining may comprise at least one adhesive section formed upon the second portion 104 and by which a periphery of the second portion 104 can be adhered to another part of the second portion 104 adjacent the first portion 102. The adhesive sections may be double sided adhesive strips, for example formed on the periphery or immediately adjacent the first portion 102, and manual manipulation may involve removing a cover strip to expose the adhesive and pressing the two parts together.

As seen in the implementation of FIGS. 1A-1J, and particularly in FIG. 1B, the second portion 104 includes a peripheral tab portion 106 forming a male part which is configured for insertion, by virtue of the resilient flexibility of the material from which the blank 100 is formed, into a shaped slot 108. The shaped slot 108 functions as a female part and is formed in the portion 104 intermediate the portion 102 and the tab portion 106. The tab portion 106 and the slot 108 are structures in the second portion that operate as a means for joining to permit interengagement thereof to render the blank 100 into an operative configuration.

FIG. 1C shows a longitudinal side elevation view of the blank 100 and FIG. 1D and end elevation view thereof depicting that the blank 100 is preferably formed of a singular unitary sheet material. As an alternative, the blank may be formed from a sheet laminate having two or more layers that provide appropriate resilient flexibility.

FIGS. 1E to 1J show various views of the blank 100 when the portion 104 is configured, for example by rolling, such that tab portion 106 is interengaged with the shaped slot 108. FIG. 1E shows a plan view of the blank 100 where the tab portion 106 is inserted through the slot 108 such that only small peripheral portions 110 of the slot 108 are visible. FIG. 1F shows the reverse side view of FIG. 1E where a major middle portion 112 of the slot 108 is visible and through which protrudes the tab portion 106. FIG. 1G shows a rear perspective view of FIG. 1F where it is apparent that the tab portion 106 extending through the slot 108 has created an opening 114 adjacent either side of the major portion 112 of the slot 108.

FIG. 1H shows a side elevation view where the tab portion 106 is seen to extend through the slot 108 and in which the configuring of the blank 100 forms a tube 116 that has or permits multiple uses, as will be described. The specific rolling configuration of this particular implementation forms a cylindrical tube. FIG. 1J is an underside view of the same arrangement illustrating the configuration of the cylindrical tube 116, together with the opening 114 and an outline of one side of the major portion 112 of the slot 108 as occluded by the tab portion 106.

When in the rolled configuration illustrated in FIGS. 1E to 1J, an article formed by the blank 100 may be used for at least two purposes. A first purpose derives from the cylindrical tube 116 being readily grasped by a user to thereby form a handle, and the first portion 102 may therefore form a blade of a fan manually operable by the user flexing the wrist or through arm movement. By virtue of the resilient flexibility of the sheet material from which the blank 100 is formed, the fan blade will flex and move air.

In an alternative use, the cylindrical tube 116 and the tab 106 extending through the slot 108, particularly as illustrated in FIG. 1H, form a support for a display stand whereby graphical illustrations or textual information printed or otherwise formed on the blank 100 at or about the first portion 102 may be displayed. In FIGS. 1H and 1I, the cylindrical tube 116 and the extending tab 106 form a base of a substantially upstanding display. In an alternative configuration, the article may be configured resting on a side either 118 or 120 such that the cylindrical tube 116 forms an upright or upstanding support for the first portion 102.

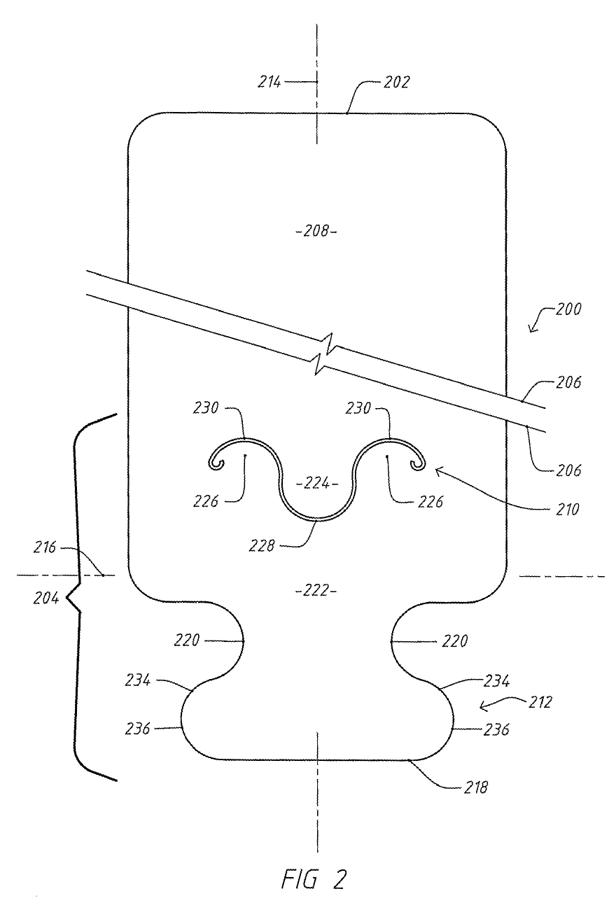

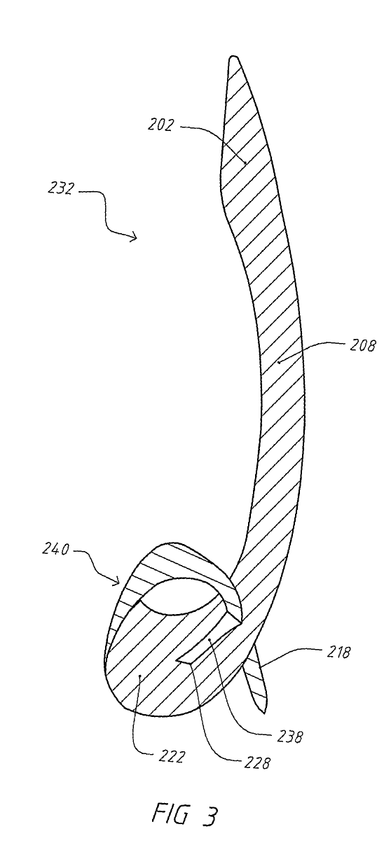

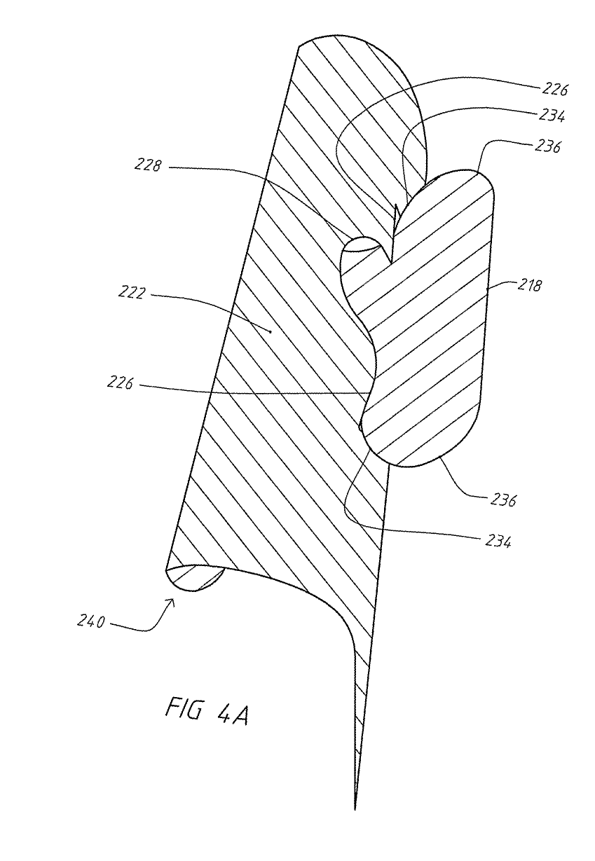

FIG. 2 shows a blank 200 which is preferably formed of plastics materials, such as a unitary sheet of polypropylene. Polypropylene has desirable properties in that, in sheet form having a thickness of between about 0.5 mm and about 1.0 mm, such is resiliently flexible and, when appropriately sized for either display stand use or use as a manually operable fan, is relatively stiff and thereby substantially self-supporting. Most preferably the polypropylene sheet is about 0.8 mm thick. Other materials having similar properties may alternatively be used. For example, where the sheet material is a laminate, such may be formed from two layers of PET (polyethylene terephthalate) laminated either side of paper card, the card for example having a density of 300 gsm. Card having densities of 450 gsm or a thickness of 500 μm may alternatively be used. In such an implementation the PET may be much thinner that the polypropylene described above. Such an arrangement may have a thickness of about 0.1 min. For example the laminate may be formed with lenticular material that call permit 3-dimensional animated-style images to be displayed.

As seen in FIG. 2, the blank 200 is substantially elongate incorporating a first free end 202 which may be used in a number of different ways, and a second end 204 incorporating structures permitting interengagement of the blank 200 for each of a multitude of purposes. As illustrated by the inclined “lightning bolt” lines 206 in FIG. 2, the length of the blank 200 may be varied according to particular applications. With the diagonal lines 206 positioned as illustrated, such may be used to vary the relative size of the first free end and an area 208 associated with the end 202 which has multiple purposes.

The second end 204 includes a slot 210 formed in the blank 200 together with a tab 212. As seen illustrated, both the slot 210 and the tab 212 are centred upon a longitudinal axis 214 and both are parallel to a transverse access 216 of the blank 200.

As illustrated in FIG. 2, the slot 210 is shown to have some amount of width, this being for illustrative purposes and so as to clearly distinguish the same from any interpretation that such is merely a marking or depression in the surface of the blank 200. In practice, the blank 200 and the structures forming this slot 210 and tab 212 are preferably formed by die cutting or stamping of the sheet material. As a consequence, the slot 210 may in practice have no discernable width but nevertheless will permit, through the resilient flexibility of the sheet material, displacement of the sheet material to create an opening through which the tab 212 is able to be inserted. As seen in FIG. 2, the tab 212 incorporates a relatively enlarged head 218 and a relatively narrow neck 220, the neck 220 forming a connection between the head 212 and a central part 222 of the second end 204 between the slot 210 and the tab 212.

The slot 210 is preferably configured or shaped in a double rams horn or sinusoidal shape to thereby form a tongue tab 224 along the longitudinal axis 214 and a pair of oppositely directed shoulder tabs 226 positioned either side of the longitudinal axis 214 and adjacent the central part 222. It will be appreciated that each of the tabs 224 and 226 substantially mate with complementary recesses 228 and 230 such that the periphery of each of the tabs 224 and 226 and the recesses 228 and 230 define the shaped slot 210. The structures 224-230 formed in the blank 200 permit deflection of the tongue tab 224 in a direction relatively opposite to each of the shoulder tabs 226 to thereby form an opening in the plane of the blank 200.

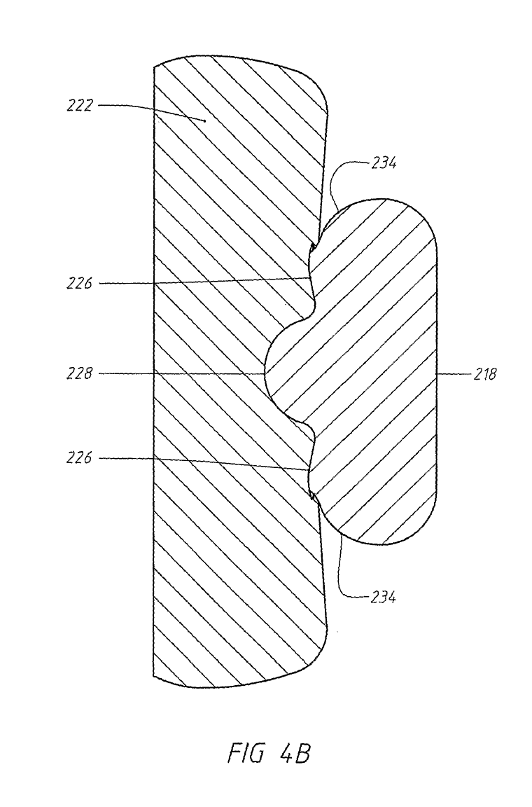

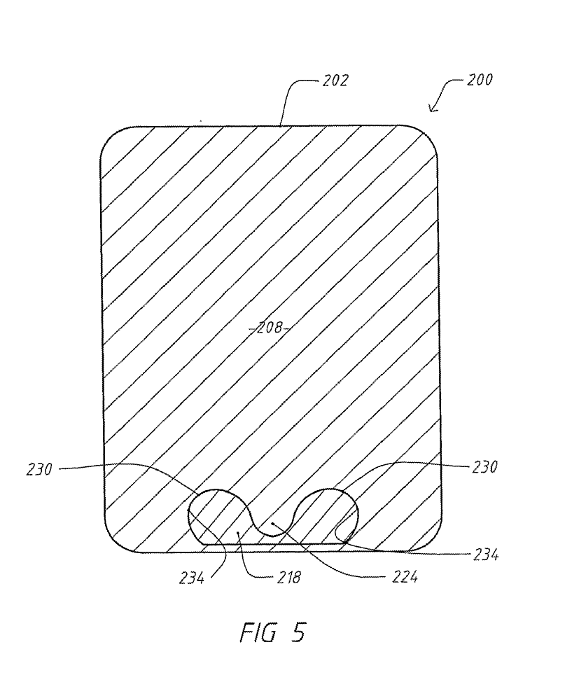

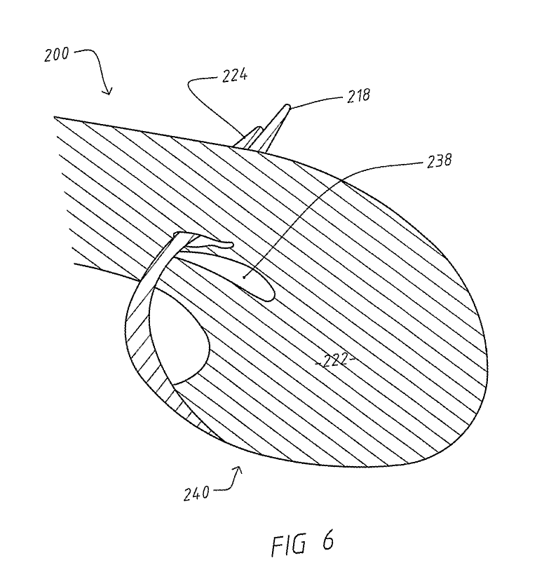

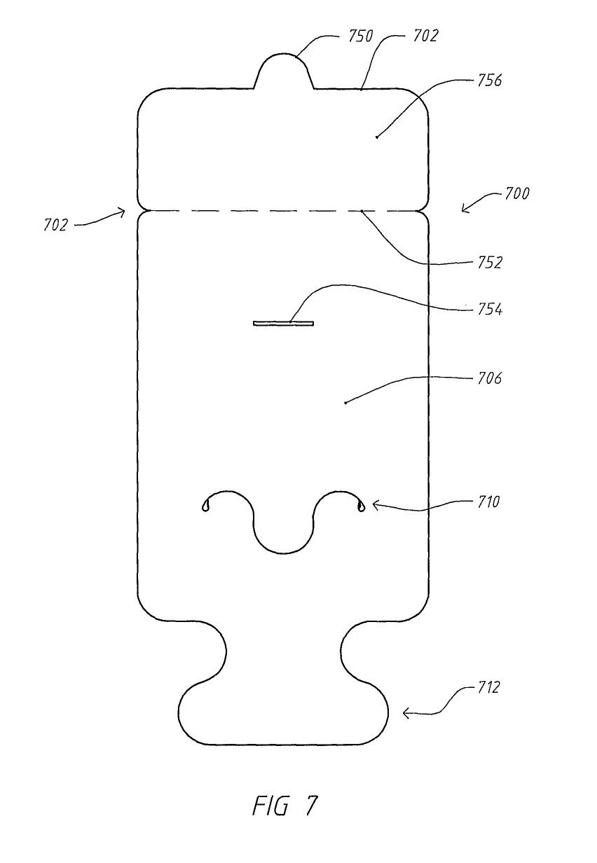

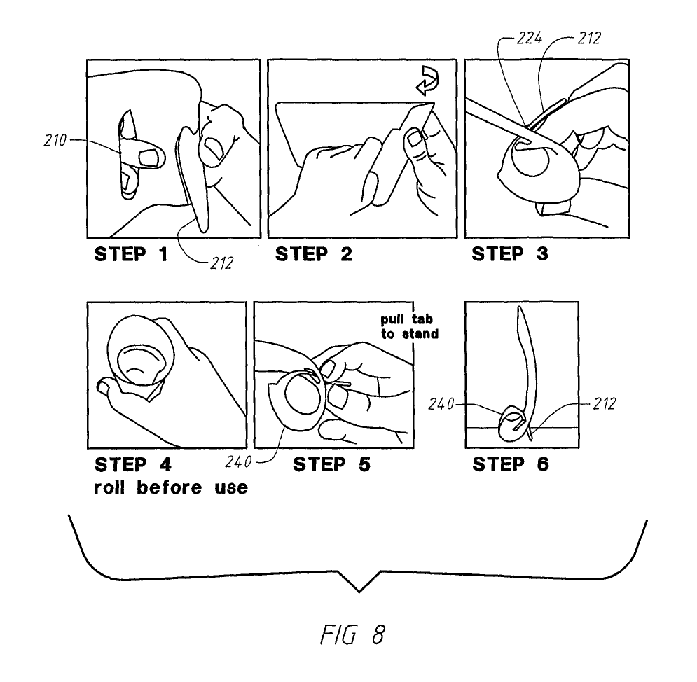

The blank 200 is configurable into an operative arrangement by rolling the second end 204 along a line passing through the central part 222 parallel to the transverse axis 216. When suitably rolled, the tab 212 is able to be operatively engaged in and through the slot 210 to provide a self connected (operable) configuration 232 illustrated in FIG. 3. As seen in FIG. 3, the recess 228 associated with the tongue tab 224 defines an opening 238 as a consequence of displacement of the tongue tab 224 by the head 218 of the tab 212. As will be apparent from FIG. 4A, when rolling and interengagement is complete, the shoulder tabs 226 substantially engage and come to rest upon an underside 234 of the head 218, the underside 234 forming an interconnection between the neck 220 and a transverse periphery 236 of the head 218. These structures are also seen in FIG. 2. FIG. 4B shows an underside plan view of FIG. 4A providing further detail of the configuration discussed above.

FIG. 5 is a rear plan view of the blank 200 rolled into the operative configuration of FIGS. 3, 4A and 4B where it is seen that the tongue tab 224 extends over one face of the enlarged head 218. Further, in view of the second end 204 being rolled about the central part 222, as is apparent from the cross hatching in FIG. 5 which is intended to distinguish between front and back faces of the sheet material, the same face of the blank 200 is presented in this view in each of the area 208 and the head 218. Further, although such may not be readily apparent in FIG. 5, the location of the recesses 230 and the corresponding undersides 234 of the head 218 form an abutting connection whereby the outline of one set of components merges into the other.

FIG. 6 shows a side perspective view of the rolled portion of the blank 200 where it is seen that the tongue tab 224 rests upon the enlarged head 218. Further, the deflection of the tongue tab 224 from the plane of the blank 220 forms the opening 238 in the structure.

FIG. 8 provides an enlarged representation of the graphical assembly instructions which, along with advertising material or other information, may be printed or otherwise formed (by adhering for example) upon the blank 200, such as in the area 208. The instructions of FIG. 8 illustrate a series of steps for manually reconfiguring the flat blank into an operative configuration. These steps will now be described with reference to the structure shown in the embodiment of FIGS. 2 to 6. In a first step (Step 1) the user inserts the forefinger through the slot 210 to thereby separate the tabs 224 and 226, deflecting the tongue tab 224 away from the tab 212, which is biased toward the slot 210 using the thumb. Step 2 involves rolling the blank 200 parallel to the transverse axis 216 about the central part 222, to direct the head 218 of the tab 212 into the slot 210 at the opening formed by the forefinger in Step 1. Step 3 shows the blank 200 illustrated from a side elevation where the tab 212 is seen extending through the slot 210 with the tongue tab 224 resting upon an “outside” of the inserted tab 212. Step 4 illustrates the rolling of the entire blank 200, as discussed above with reference to FIG. 8. Step 5 shows the user pulling the tab 212 outwardly after the rolling of step 4 to thereby adjust the resilience and stiffness of the sheet material such that the tab 212 and resting tongue tab 224 form something of a leaf spring extending from the cylindrical tube 240. Lastly, step 6 show the article configured for use as a display in side elevation view where the tube 240 forms ballast engaging the surface of a table and the extending tab 212 engaging the table to provide support to the upstanding article.

As indicated above, in a preferred implementation the blank 200, 300 is formed of polypropylene sheet having a preferred thickness of between 0.5 mm and 1.0 mm. Whilst the overall dimensions of blank may be varied according to particular implementations for either fan or display, the present inventor has found that a length of about 300 mm and a width of about 120-130 mm is convenient for bulk packaging in a flat configuration, and for ease of subsequent rolling and manipulation for use as either a fan or as a display. Further, the width of about 120-130 mm and the length indicated permit easy insertion of the rolled blank into a shirt or trouser pocket for carriage. Other sizes may be used depending upon specific requirements. The present inventor has found about 250 mm to be a workable minimum blank length and about 100 mm as a workable minimum width. It will be further appreciated that the blank, when the rolled operative configuration as a fan or a display, may be disengaged from such configuration to revert into the flat sheet arrangement for stowage and possibly subsequent reassembly as described. The fastening arrangement is therefore releasable.

The arrangements illustrated in FIGS. 1 to 8 provide only basic configuration of a blank which may be configured for use as a fan or display. Further, in the display configuration, for example as illustrated in FIG. 3, whilst such is illustrated in an upstanding position where the tube 240 forms ballast at the base of the stand, the same configuration may be arranged on its side where the tube 240 is substantially vertical and the circular edge of the tube 240 together with the elongate extension of the side of the blank associated with the area 208, forms a base of a “sideways” display. The ballast is operatively configurable, in either of two ways, upon a surface to permit the arrangement to operate as a display.

Various other configurations of the blank may be used.

FIG. 7 shows a further blank 700 having a tab portion 712 that is releasably engagable with a slot 710, like the embodiment of FIG. 2. In the blank 700, a first end 702 is provided with a flap portion 756 coupled via a hinge section 752 to a main body 706 of the blank 700. As illustrated, the flap portion 756 includes a peripheral tab 750 longitudinally aligned with a straight slot 754 arranged in the main body 706 intermediate the hinge 752 and the shaped slot 710. With this configuration, the flap 756 may be is folded over the main body 706 and the tab 750 engaged into the slot 754 to keep the flap 756 in a closed position occluding part of the main body 706. The tab 750 may be removed from the slot 754 and hinged open to reveal printed matter on surfaces of the blank 700. The blank 70 may be used for display purposes, where the sheet material is common throughout. In fan implementations, the blank 700 may be formed such that the flap 756 includes one or more additional laminated layers, which add weight to that portion to aid a flapping or oscillating motion when in operation.

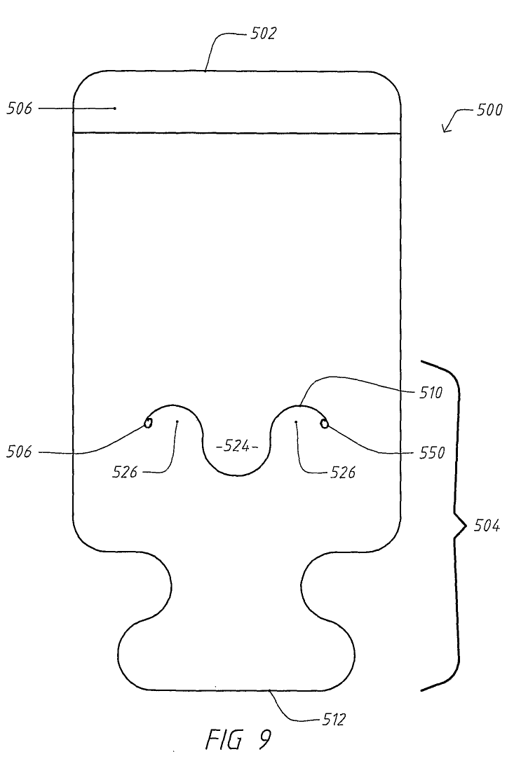

FIG. 9 shows a further embodiment of a blank 500 having a first end 502 and in which a second end 504 is configured similarly to the previously described embodiments. In the embodiment of FIG. 9, the first end 502 is adapted to include additional weight through the addition of a further one or more layers of sheet material 506 which may be adhered to the underlying blank through use of an adhesive or other means such as ultrasonic welding. Alternatively, a small folded section, akin to that of FIG. 7, may be used to act as a counterweight at the end 502. The purpose of the adding weight is to increase the flexing or rebound of the end 502 during fan operation. Alternatively, additional physical weights may be used. Such may include fixing magnets or the like to the end 502, again, for example using adhesive or other means such as press studs. The magnets in such a position permit the blank 500, either in the flat or rolled configuration, to be temporarily affixed to a ferromagnetic surface such as steel, for example as commonly found in domestic refrigerators. Other types of magnet may be used, this including flexible strip magnets, as commonly found fastened to domestic refrigerators.

The above described arrangements show only a single male part and a corresponding female part (a single couple) to permit interengagement, alternate configurations may use plural male parts and corresponding female parts (multiple couples). For example, the illustrated tab portion 212 and slot 210 of FIG. 2, may be varied (reduced relatively) in size and two or three of such couples used for manually configurable self coupling of the end 204. Where two couples are used, such may be evenly spaced either side of the axis 214. Where three couples are used, one couple may remain positioned upon the axis 214 and the other two spaced either side thereof.

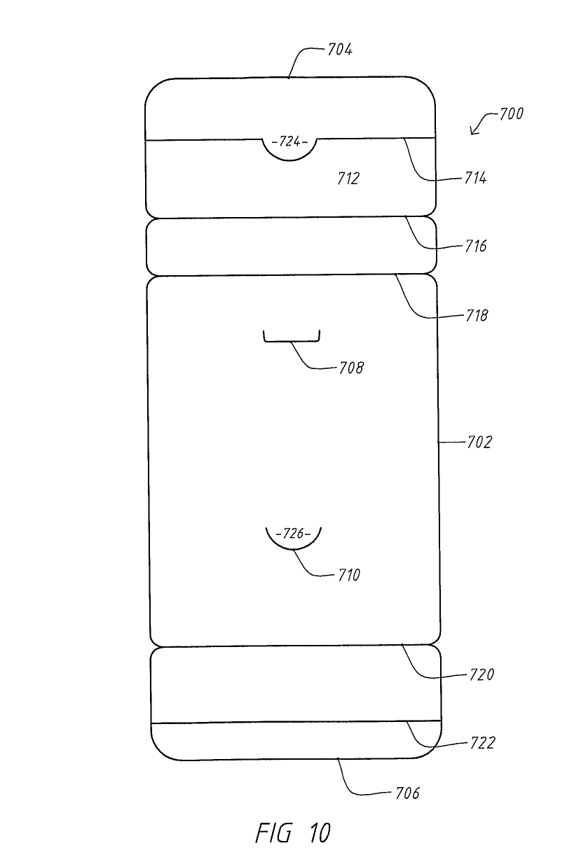

FIGS. 10 to 22 show a number of other embodiments which are preferably manufactured from paper board (eg. cardboard or similar products). Such board may be laminated with other materials and, where appropriate, manufactured from recycled paper materials. Such board and paper materials when appropriately manufactured have resilient flexibility, although not as significant as polypropylene, for example. The resilient flexibility of such materials permits fan/display articles to be formed and which are sized to be manually grasped in a single hand and operated as a traditional fan, whilst also be able to be used statically as a display. The paper board materials may typically have a thickness of between 0.5 mm and 2 mm, usually about 0.8-1.0 mm. The board material may be laminated.

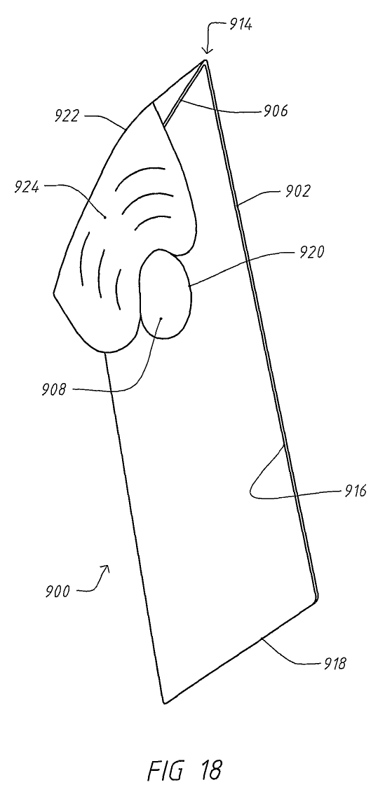

FIG. 10 shows a blank 700 which is a substantially rectangular shape and includes a main body section 702 interposed between two ends 704 and 706. The first end 704 includes a number of fold lines 714, 716 and 718 that permit the end 704 to be folded into a triangular shaped tube (best seen in FIG. 18). The end 704 incorporates a cut 712 on the fold line 714 which forms a tab that is insertable into a slot 708 formed in the main body 702.

The second end 706 includes two fold lines 720 and 722 which are configured to fold to provide for engagement of the end 706 under a tab 726 formed by a cut 710 to thereby secure the flap formed between the folds 720 and 722. In this regard, whilst the fold line 720 provides for the entire end 706 to be folded over the main body 702, the fold line 722 is provided to permit a limited fold sufficient to bias the end 706 into the slot 710 under the tab 726.

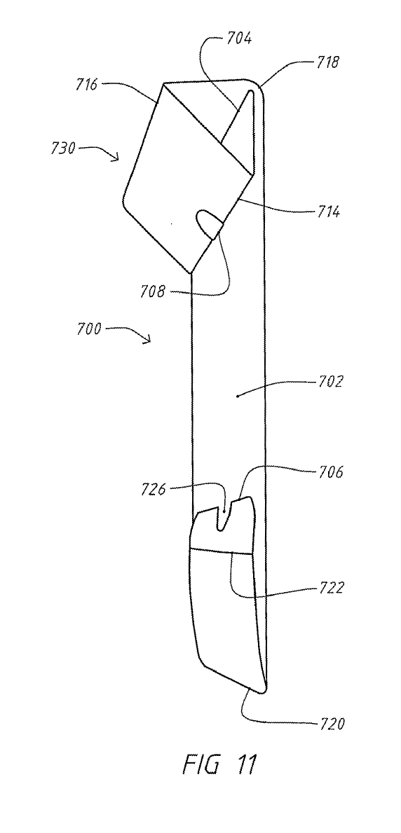

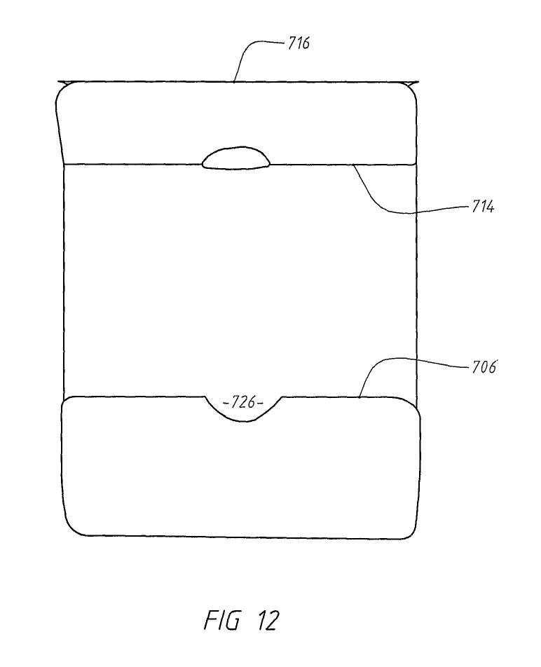

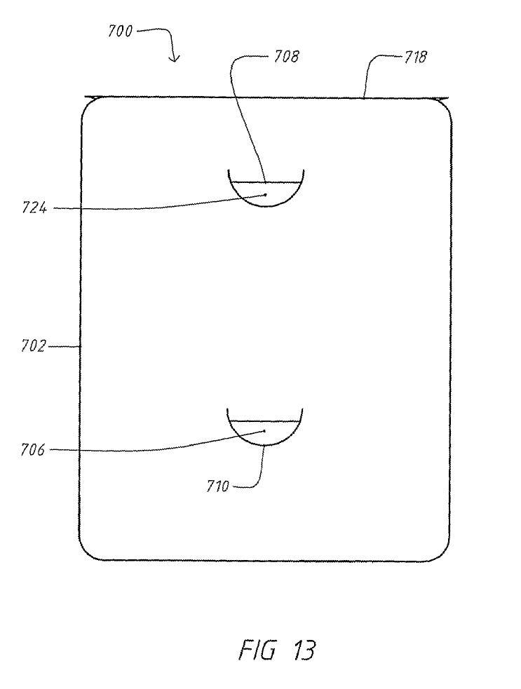

FIG. 11 shows a side perspective view of the blank 700 when formed. As can be seen, the folding of the end 704 along each of the fold lines 714, 716 and 718 forms a triangular cross-section shaped tubular structure 730 which may be used to form a base so that the blank 700 when formed may be used a display. Further, the triangular section 730 may be used as a handle for the article to be operated as a fan. FIG. 12 shows a plan view of the arrangement of FIG. 11 and FIG. 13 shows an inverse plan view of FIG. 11 showing the arrangement of the various tabs 724 and 726.

As will be seen from FIG. 10, each of the fold lines 716, 718 and 720 has associated at its periphery a nib portion in the edge of the blank 700. Each nib is configured to provide for ease of folding and a consequential rounded, non-sharp edge or corner at the fold. No such nib is provided at the fold line 714 since that fold line lies in the plane of the main part 702, as seen in FIG. 18. No further no nib is required at the fold line 722 as such is only a minor fold again essentially in the plane of the main part 702.

In the example of FIGS. 10-13, a preferred length of the blank 700 is about 360 mm, this being associated with a width of about 150 mm. This gives a blade length of about 160 mm.

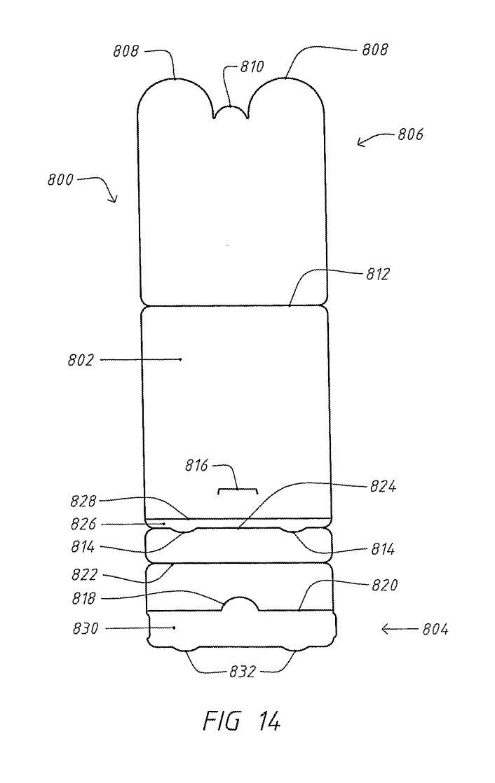

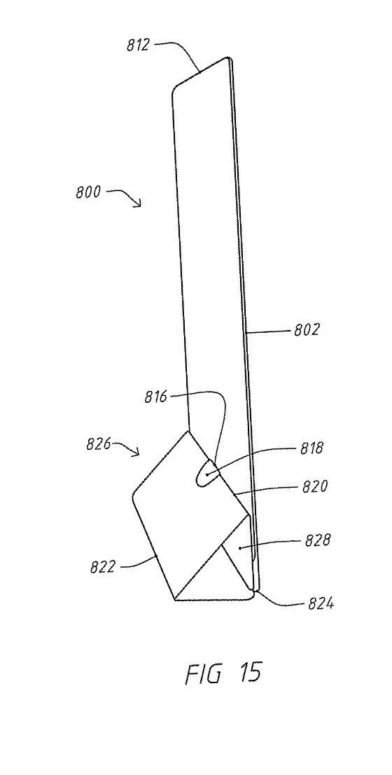

FIG. 14 shows a further blank 800 also preferably manufactured of paper board materials. The blank 800 is seen to be generally rectangular and has a main body 802 together with a first foldable end 804 and a second foldable end 806. As seen, the end 806 is formed with two peripheral semi-circular major tabs 808 and intermediate connecting minor tab 810. The end 806 is able to be folded along a fold line 812 such that the peripheries of the tabs 808 are each locatable at or within a corresponding small slot 814 formed intermediate the main body 802 and the end 804 along a fold line 824. As best seen in the formed configuration seen in FIG. 15, when the end 806 is folded along the line 812, the minor tab 810 is insertable into a slot 816 formed in the main body 802. The slot 816 is also configured to receive a tab 818 formed adjacent the end 804 along a fold line 820. A further fold line 822, the fold line 824, and a padding section 826 formed using another (minor) fold line 828, provide for the end 804 to be folded to form a substantially triangular tubular section 826, best seen in FIG. 15. When so folded, the tab 818 is able to be engaged through the slot 816.

Although not labelled in FIG. 15 (for the sake of clarity), the end 806 formed by the tabs 808 becomes sandwiched between the main body 802 and a section 830 formed between the end 804 and the fold 820.

As further seen in FIG. 14, the end 804 includes two outwardly protruding minor tabs 832 which, when the end 804 is folded and formed according to FIG. 15, are configured to engage into the small slots 814 adjacent each of the tab portions 808. This structure, together with the engagement of the tab 818 in the slot 816, provides for substantial locking of the structures formed by and defining the tubular section 826.

As with the previous examples, the tubular section 826 permits the formed structure of FIG. 15 to be used as a display or held as a handle for a manually operable fan. Because the materials from which this article is manufactured are generally flexible under manual manipulation, manual manipulation of a formed structure to obtain an upstanding article may be necessary depending upon the accuracy of formation.

As with the previous example, nibs on the edges of the folds are used to ensure ease of folding and to be prevent sharp corners. The main body 802 may be between 180-200 mm long and the width varied according to proportion or specific application (eg: sized to fit male or female trouser pocket).

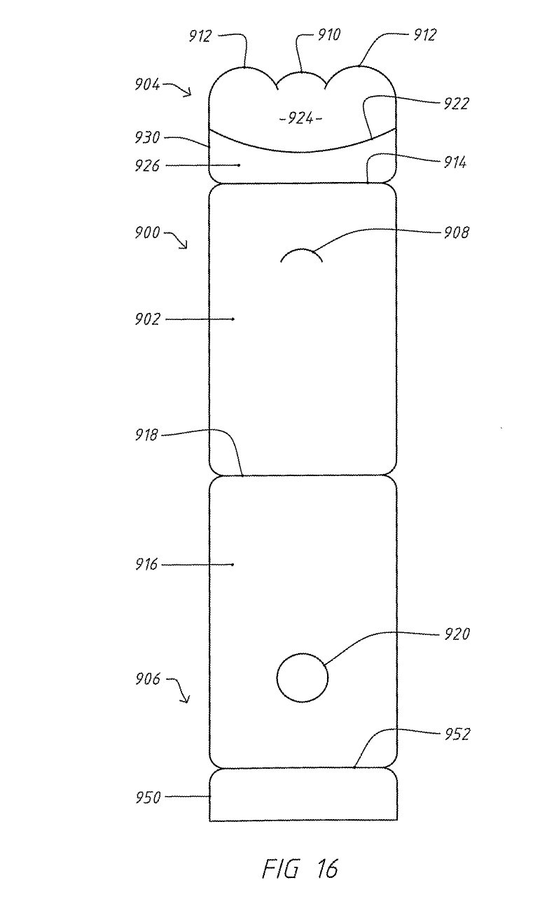

FIG. 16 shows a further embodiment of a blank 900. The blank 900 includes a main body portion 902 and a first foldable end 904 and an opposite foldable end 906. The main body 902 includes a curved slot 908 which is configured to receive a minor tab 910 formed between two curved major tab portions 912 which collectively define the end 904. The end 904 is foldable along a major fold line 914 to permit engagement of the minor tab 910 into the slot 908.

The end 906 defines a foldable portion 916 at a further major fold line 918 which permits the portion 916 to be folded to substantially overlap the main body 902. The end 906 includes a circular hole 920 formed in the paper board material which is configured, when the end 906 is folded over the main body 902, to expose the slot 908. When exposed, and the end 906 so folded, the end 904 may be folded at the fold line 904 to engage in the slot 908 through the hole 920.

As further seen in FIG. 16, the end 904 includes a curved minor fold line 922 which provides, when the article is formed, a concave surface 924 defined by the various structures. The combination of the straight major fold line 914 and the curved minor fold line 922 provide for the minor tab 910 to be resiliently biased into the slot 908, either through or not through the hole 920. This creates a tubular section which may be grasped, such operation action to manually maintain the engagement to thereby retain the structure.

Also seen in FIG. 16, the end 906 includes a double-flip portion 950 connected to the section 916 by a fold line 952. The fold line 952 may be perforated thereby permitting removal of the portion 950 from the blank 900. This may be used to perform a marketing purpose, where the removed portion 950 may operate as a voucher, token, business card or other reference. The portion 950 also aids physical operation of the a fan formed from the blank 900 as it improves lower blade/handle resilience and rigidity, therefore aid in the development of fan power. FIG. 16 illustrates a configuration by which a male part (910) may engage more than one female part (908, 920).

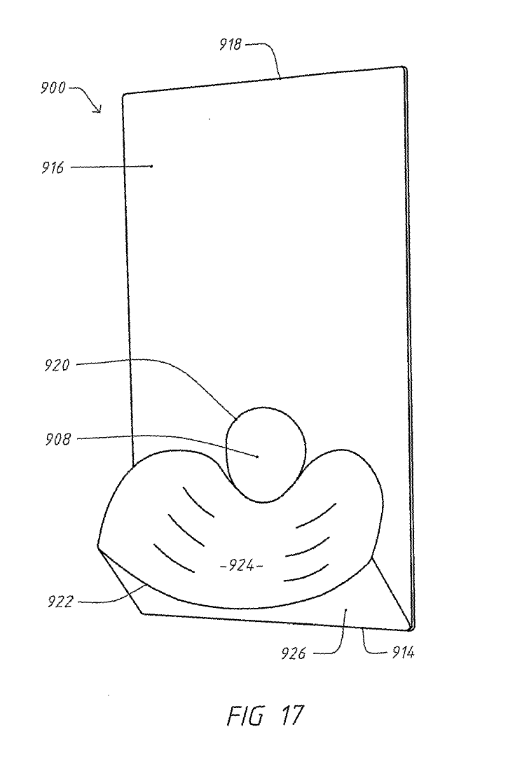

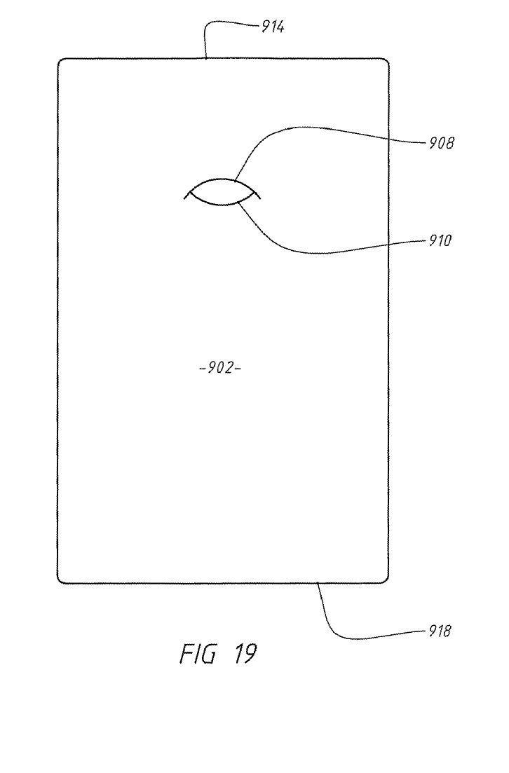

The formed configuration is seen in FIGS. 17 and 18 where the folding a releasable interengagement is seen to form a substantially triangular tubular structure. FIG. 17 is a perspective view from above of the formed arrangement and FIG. 18 shows a perspective view from the side illustrating the layering of the various sections. FIG. 19 shows an inverse plan view of the formed arrangement where the minor tab 910 is seen protruding from the space formed by the slot 908. As seen in FIG. 17, the concave surface 924 depends from a back portion 926 defined between the curved fold 922 and the fold line 914.

The blank 900 as formed in FIGS. 17 and 18 may be used as a fan and also as a display. The fan configuration may be performed by the user grasping the curved portion and the tubular section formed thereby. Because of the nature of the concave portion, however, the article of FIGS. 17 and 18 is not able to be stood on its end, as are the previous arrangements. Rather, the article is able to be stood on its side resting against one edge of the main body 902 and fold section 916, and also upon a straight edge 930 between the fold lines 914 and 922.

The concave surface 924 formed in the folded configuration of FIGS. 17 and 18 also permits the article to be used as a display when laid flat upon a table or other surface. The concaved surface 924 is therefore inclined and somewhat upstanding and can be readily viewed by persons looking down upon the article. The blank 900 of FIG. 16 desirably has an overall length of about 500 mm, but such may be between 400 and 600 mm.

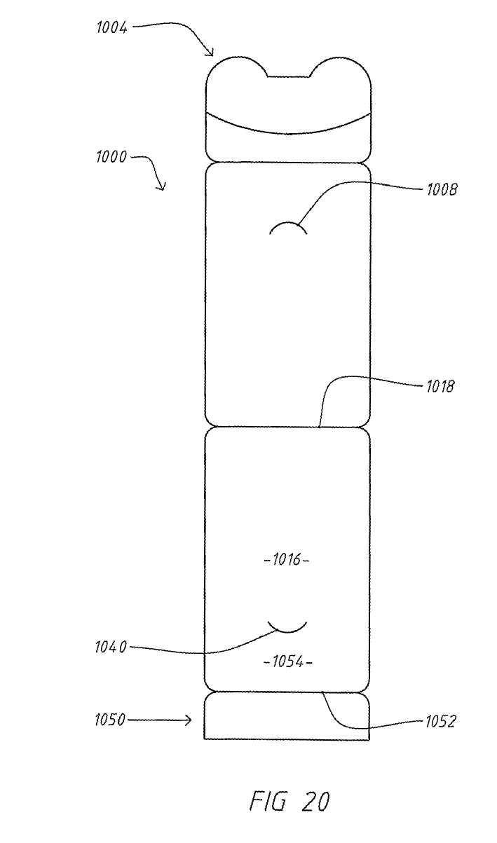

FIG. 20 shows a further blank 1000 whose structures are akin to the blank 900 excepting that the hole 920 has been replaced by a slot 1040 which is configured to complement a slot 1008 when the end 1016 is folded along the major fold line 1018. An end 1004, in all other respects, corresponds to the arrangement of FIG. 16. A further foldable section 1050 is provided which, when folded along a major fold line 1052, is able to overlap an area 1054 between the slot 1040 and the fold line 1052. Engagement in the slot 1040 may also be provided for depending upon the length of the section 1050. The blank 1000 desirably has an overall length of between 530 mm-550 mm.

Each of the arrangements of FIGS. 10 to 20 may, as with previous arrangements, be printed or otherwise adorned with textual or image matter upon any of their surfaces to provide for advertising and/or information delivery. Assembly instructions consistent with the respective description of each article can be provided in the manner as described above.

The arrangements of FIGS. 10 to 20 by virtue of their hard fold lines permit manufacture of fans and displays from essentially rigid but mildly flexible materials such as paper board and the like. Polypropylene as used in the previous embodiments may also readily folded along a definite seam, but can become brittle at that seam which may obviate disassembly and reassembly. Paperboard on the other hand, is readily foldable along seam lines whilst at the same time being inexpensive and able to be conveniently manufactured and disposed of. The polypropylene configurations described may be used where the information contained upon the article is intended to persist over a period of time. Nevertheless, the polypropylene configured arrangements are readily recyclable as are many other plastics materials such as PET.

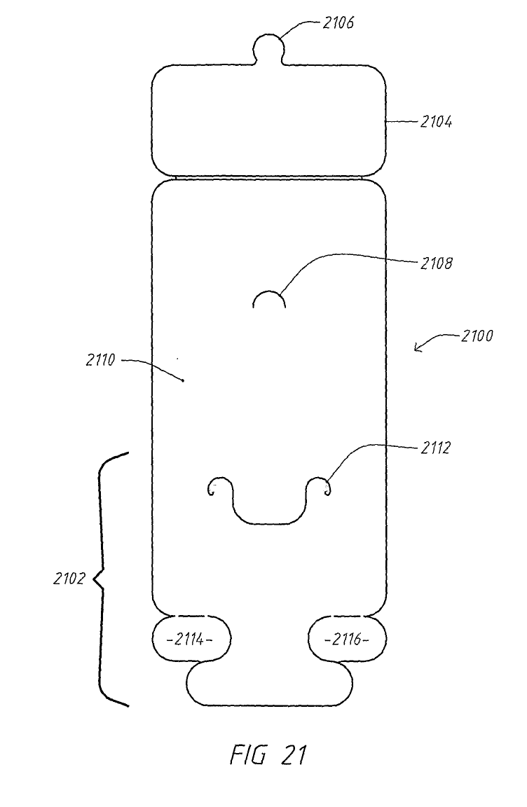

FIG. 21 shows a blank 2100 similar to that of FIG. 9 and which is preferably manufactured of polypropylene or like plastics materials and in which a first portion 2102 is configured for rolled interengagement as in the example of FIGS. 1 to 3. A slot 2112 is provided to permit such interengagement and has a flatter shape than similar slots of other blanks. The blank 2100 includes a foldable section 2104 having a central peripheral tab 2106 configured for engagement upon folding with a semi-circular slot 2108 positioned with an operative planar section 2110 of the blank 2100. The blank 2100 also includes tokens 2114 and 2116 integrated into the portion 2102 using perforated joins and which are configured to be removed to enable the rolled interengagement of the portion 2102. The tokens 2114 and 2116 may be used for marketing purposes.

The foregoing describes only a number embodiments of the present invention and modifications can be made thereto without departing from the spirit and scope of the present disclosure.

For example, the fastening arrangement incorporating the slot and tabs of the various embodiments may be modified in their respective shapes to achieve similar engagement upon rolling and semi-permanent affixing of one end of the blank to a more central portion. In this regard, the preferred slot being a double rams horn shape, may be tempered in its extent of undulation depending upon the particular shape of the tab 212. Other shapes may also be used. For example a V-shaped slot can be used to form a single displaceable tab in the sheet material through which an appropriately shaped head of a peripheral tab portion may be inserted. An S-shaped slot can be used to form two tabs in the plane of the sheet material for interengagement with a suitably shaped peripheral tab portion. A W-shaped slot can afford similar functionality to the illustrated arrangement. A sinusoidal shape may also be used. The double rams horn shape may be squared as desired to resemble a square channel. In each of these alternatives, a mentioned above, it is desirable that sharp corner or transitions be avoided to prevent user injury, and hence the references to the V, W and stepped channel slots are intended to be to shapes substantially akin thereto. As seen from FIGS. 10-20, the fastening arrangement may have a relatively simple slot, that is singularly curved (908 in FIG. 16), substantially straight (816 in FIG. 14) or circular slot or cut-out (920 in FIG. 16). Particularly seen in FIG. 16, combinations of slots may be used, and so slots selected from the above may be implemented in the fastening arrangement.

Further, whilst each of the embodiments described illustrate a rectangle-shaped blank, it will be appreciated that the shape of the blank may be varied. In this regard, the first end (eg. 202) may be circular, cloven leaf, or tear drop in shape depending upon the particular application. The rectangular shape is convenient as it optimises use of a sheet substrate from which the blanks may be pressed or cut, whilst being sized for convenient storage either when in the flat form or when in the rolled form, as discussed above. Other shapes may not be so conveniently stowed in either configuration.

1. A blank formed of resiliently flexible sheet material, said blank comprising a first portion operative in a planar configuration and a second portion having means for joining thereof upon configuring of the second portion to form a tubular structure.

2. A blank according to claim 1 wherein said means for joining comprises structures permitting operative interengagement of the second portion.

3. A blank according to claim 2 wherein said structures comprises at least one peripheral male part configured for insertion and engagement with a corresponding female part located adjacent the first portion.

4. A blank according to claim 3 wherein the male part comprises a tab having an enlarged head at a periphery of the second portion and a relatively narrow neck interposed between the head and the female part.

5. A blank according to claim 3 wherein said female part comprises a shaped slot formed in the sheet material, the slot forming at least one tab displaceable from a plane of the sheet material to form an opening through which the male part is insertable.

6. A blank according to claim 5 wherein said slot is shaped to form at least two tabs.

7. A blank according to claim 5 wherein said slot is shaped to form three tabs.

8. A blank according to claim 5 wherein the shaped slot comprises at least one of a double rams horn shape, a sinusoidal shape, a substantial V-shape, an S-shape, a substantial W-shape, and a substantial square channel shape, a substantially straight slot, a singular curved slot, and a circular slot or cut-out.

9. A blank according to claim 3 wherein the sheet material is substantially elongate and has a longitudinal axis, there being one each of said male and female parts positioned upon the longitudinal axis.

10. A blank according to claim 9 wherein the sheet material is substantially rectangular in shape with the male part being formed at one end thereof and the female part being formed intermediate the two ends of the rectangle.

11. A blank according to claim 10 wherein the second portion is configured to be rolled along a transverse axis of the sheet material between the male and female parts to form a substantially cylindrical tube.

12. A blank according to claim 1 wherein the sheet material comprises one or more layers of material.

13. A blank according to claim 12 wherein the sheet material has a thickness between about 0.1 mm and about 2.0 mm, and more preferably between about 0.5 mm and about 1.0 mm.

14. A blank according to claim 12 wherein the sheet material has a length of about 250 mm to about 550 mm and a width of about 100 mm to about 150 mm.

15. A blank according to claim 1 wherein the configuring comprises rolling and said tubular structure comprises a cylindrical tube.

16. A blank according to claim 15 wherein the interengagement is releasable to revert the cylindrical tube to a substantially sheet form.

17. A blank according to claim 13 wherein the sheet material is formed of a single layer of polypropylene.

18. A blank according to claim 1 wherein at least the first portion incorporates graphical or textual matter.

19. A blank according to claim 18 wherein the second portion incorporates graphical illustrations of the configuring of the blank into operative interengagement.

20. A blank according to claim 1 further comprising a weighted section formed at a periphery of the first portion.

21. A method of configuring a blank to form an article, said method comprising the steps of:
providing a blank formed of resiliently flexible sheet material; and
configuring one portion of the blank to operatively engage a peripheral male part thereof with a female part thereof;
the engaging forming a tube from the one portion and from which extends another operatively planar portion of the blank.

22. A method according to claim 21 wherein the male part comprises at least one tab part and the female part comprises a corresponding shaped slot, and said configuring comprises rolling the material into a cylindrical tube, said method further comprising:
displacing at least one tab associated with the shaped slot to form an opening in the sheet material and inserting the corresponding tab part into the opening to thereby form the cylindrical tube.

23. A manually operable fan formed from a resiliently flexible sheet material, said fan comprising a blade and a handle, said handle comprising a first portion of the sheet material configured and interengaged therewith to form a tube, the blade comprising a remaining portion of the sheet material extending from the tube.

24. A fan according to claim 23 wherein the handle comprises a cylindrical tube configured from the sheet material.

25. A fan according to claim 23 wherein the first portion comprises a peripheral tab portion and a shaped slot adjacent the remaining portion, the tab portion being releasably engagable with the slot upon rolling to form the handle.

26. A fan according to claim 23 further comprising graphical or textual matter printed upon at least the blade.

27. A display article formed from a resiliently flexible sheet material, said display article comprising a planar display area and a ballast section, said ballast section comprising a first portion of the sheet material interengaged therewith to form a tubular section, the display area comprising a remaining portion of the sheet material extending from the tubular section, the ballast section being operatively configurable upon a surface to present the display section for display of textual and/or graphical matter formed on the display area.

28. A display article according to claim 27 wherein said sheet material is rolled to form a cylindrical tubular section.

29. A display article according to claim 27 wherein the textual and/or graphical matter is formed on the sheet material by printing.

30. A display article according to claim 27 wherein the first portion comprises a tab interengagable with a slot, the tab extending through the slot to form a support for the display extending from the tubular section.

31. A blank according to claim 1 wherein the means for joining comprises at least one adhesive section formed upon said second portion and by which a periphery of said second portion can be adhered to said second portion adjacent said first portion.

32. A blank according to claim 1 wherein said sheet material comprises a paper board and the means for joining comprises a plurality of fold lines in the sheet material to permit folding of the second portion to form the tubular structure.

33. A blank according to claim 32 wherein the second portion comprises at least one structure configured to engage a slot to secure a fold of the sheet material.

34. A blank according to claim 33 wherein said one structure comprises a tab associated with an end of the sheet material.

35. A blank according to claim 33 wherein said one structure comprises a structure interposed between two tabs, the structure being engagable with the slot.

36. A blank according to claim 32 wherein the first portion comprises at least two sections, a fold line joining the sections, and permitting a folding of a peripheral one of the sections over the other.

37. A blank according to claim 36 wherein the peripheral section comprises means for securing the folding.

38. A blank according to claim 32 wherein the tubular structure is of substantially triangular cross-section.

39. (canceled)

40. (canceled)
